(19) United States
(12) Patent Application Publication
(10) Pub. No.: US 2024/0123433 A1
(43) Pub. Date: Apr. 18, 2024

(54) SELECTIVE HYDROCRACKING OF NORMAL PARAFFINS

(71) Applicant: CHEVRON U.S.A. INC., San Ramon, CA (US)

(72) Inventors: Cong-Yan CHEN, Kensington, CA (US); Theodorus Ludovicus Michael MAESEN, Moraga, CA (US); Tracy Margaret DAVIS, Novato, CA (US); Dan XIE, San Ramon, CA (US)

(73) Assignee: CHEVRON U.S.A. INC., San Ramon, CA (US)

(21) Appl. No.: 18/270,208

(22) PCT Filed: Dec. 29, 2021
(86) PCT No.: PCT/IB2021/062433

§ 371 Date: Jun. 29, 2023

Related U.S. Application Data
(60) Provisional application No. 63/132,039, filed on Dec. 30, 2020.

(51) Int. Cl. B01J 29/068; B01J 35/64; C10G 47/18

(52) U.S. Cl. CPC B01J 29/068; B01J 35/643; C10G 47/18; B01J 2229/20; B01J 2229/42; C10G 2300/1033

(57) ABSTRACT

Provided is a process for hydrocracking normal paraffins into lighter normal paraffins with minimal formation of iso-paraffins. The process comprises hydrocracking a hydrocarbon feedstock comprising normal paraffins under hydrocracking conditions. The reaction is run in the presence of a selected catalyst, e.g., an LTA-type zeolite, with a requisite topology and acid site density. The zeolite has a framework type with voids greater than 0.50 nm in diameter, which are accessible through apertures characterized by a longest diameter of less than 0.50 nm and a shortest diameter of more than 0.30 nm. The reaction conducted in the presence of such a selected zeolite produces an n-paraffin rich product.

### CROSS REFERENCE TO RELATED APPLICATIONS

This application claims the benefit of priority to U.S. Provisional Patent Appl. Ser. No. 63/132,039, filed on Dec. 30, 2020, the disclosure of which is herein incorporated in its entirety.

### TECHNICAL FIELD

Process for hydrocracking normal paraffins into lighter normal paraffins with minimal formation of iso-paraffins, and process for selecting the catalyst.

### BACKGROUND

For a century, hydrocracking and catalytic cracking have been used to reduce the boiling point and to increase the H/C ratio of crude oils and coal-derived liquids in refineries. Inherently, these catalytic processes also increased the iso-paraffin content of the lighter fractions. This was desirable when the intended use of the cracking products was an internal combustion engine. However, crude oil is now increasingly used for chemical manufacture, and high iso-paraffin content has become an undesirable side effect of acid-catalyzed (hydro)cracking.

Nobel Laureate George Olah established that acid catalysts do not crack n-paraffins directly into n-paraffins. Instead acids first catalyze the conversion of n-paraffins into iso-paraffins, and only then do they crack the iso-paraffins. Consequently, a product slate with a high iso-paraffin content is generally considered the signature of acid-catalyzed cracking. By contrast, a product slate with a high n-paraffin content is the signature of thermal cracking (pyrolysis).

Historically, C₅₊ liquids rich in normal paraffins have been prepared by selectively extracting normal paraffins from mixtures, such as petroleum. This operation is relatively expensive and is limited to the content of normal paraffins in the feedstock. For example, harvesting particularly the longer paraffins from an adsorbent, e.g., in a pressure swing adsorption process, requires an expensive and convoluted desorption step. Normal paraffins can also be produced in the Fischer Tropsch process. However, the Fischer Tropsch process also generates heavy products that can fall outside of the range of use for the above applications. If these heavy products are converted into lighter products by hydrocracking over conventional acidic catalysts, an iso-paraffin-rich product will be obtained, not a normal paraffin-rich product.

Selective cracking of heavy normal paraffins to lighter normal paraffins has been disclosed in the art. For example, note U.S. Patent Publication No. 2007/0032692.

In G. E. Langlois, R. F. Sullivan, and Clark J. Egan, “Hydrocracking of Paraffins with Nickel on Silica-Alumina Catalysts—the Role of Sulfiding,” Symposium on The Chemical and Physical Nature of Catalysts Presented Before the Division of the Petroleum Chemistry, American Chemical Society, Atlantic City Meeting, Sep. 12-17, 1965 (Table 1, page B-128), the conversion of n-decane (n-C₁₀) over silica alumina with different metals during hydrocracking is described.

Nickel without sulfiding gives C₄-C₇ products with low i/n ratios (0.08), but the conversion of this catalyst is very low (7.8%), and methane yields are relatively high (0.28 wt. %). In comparison a sulfided nickel catalyst on the silica alumina has high conversion (52.8), and low methane yields (0.02 wt. %) but gives C₄-C₇ products with high i/n ratios (6.6). Catalysts are now described that have the combination of good activity, low i/n ratio products, and low methane make. Jule A. Rabo, “Unifying Principles in Zeolite Chemistry and Catalysis,” in Zeolites: Science and Technology, editor F. Ramoa Ribeiro et al., NATO ACS Series Vol. 80, pages 291-316, 1984 (page 295-296) discloses the use of alkali-neutralized zeolites that are free of acidic hydroxyls for cracking hexane. However, this reference discloses cracking and not hydroconversion, and significant quantities of methane (3.1 wt. %) and olefins are produced.

Harry L. Coonradt and William E. Garwood, “The Mechanism of Hydrocracking,” I&EC Process Design and Development, Vol., 3 No. 1, January 1964 pages 38-45 describes the use of a platinum on silica alumina catalyst for hydrocracking hexadecane (n-C₁₆), n-heptane and n-docosane (n-C₂₀ also known as eicosane), while producing low levels of methane. Significant amount of cycloparaffins are also produced, and the product is isomerized (as noted on page 40, 1^{st} column), but the extent of isomerization is not known. While the pore properties of the support for this catalyst are not described, it probably was not microporous, as shown by the formation of cycloparaffins and iso-paraffins.

B. S. Greensfelder, H. H. Voge, and G. M. Good, “Catalytic and Thermal Cracking of Pure Hydrocarbons,” Industrial and Engineering Chemistry, November 1949, pages 2573-2584, describes the evaluation of different classes of catalysts for conversion of cetane (n-C₁₆). Of particular note, activated carbon gives lower yields of methane than a thermal reaction, but still produces significant amounts of methane and also significant amounts of ethane, propane and butane. It was noted that very little chain-branching (formation of iso-paraffins) was observed (page 2576, col 2, 2^{nd} paragraph). However, as with other cracking studies, significant quantities of olefins were produced, and yields of gases were excessive.

There is an urgent need in the industry to diversify the crude oil value chain away from fuels. It is now important to turn crude oil into a superior steam cracking feedstock. Iso-paraffins are a less desirable steam cracker feed stream in that they generate desirable olefins, but at the cost of significant quantities of undesirable pyrolysis oil. The industry would welcome a straight-forward and efficient catalytic process for hydroconverting normal paraffins into lighter normal paraffins with minimal formation of iso-paraffins.

### SUMMARY

Provided is a process for hydrocracking normal paraffins into lighter normal paraffins with minimal formation of iso-paraffins. The process comprises hydrocracking a hydrocarbon feedstock comprising normal paraffins under hydrocracking conditions. The feedstock generally comprises at least 3 wt. %, or in one embodiment, at least 5 wt. %, normal paraffins. The reaction is run in the presence of a specific type of zeolite-based catalyst, with the zeolite having a requisite topology and acid site density. The present zeolite is of a framework type with voids greater than 0.50 nm in diameter, which are accessible through apertures characterized by a longest diameter of less than 0.50 nm and a shortest diameter of more than 0.30 nm. The zeolite, e.g., in one embodiment, is an LTA-zeolite. The reaction conducted in the presence of such a zeolite produces an n-paraffin rich product that needs no separation step before being fed to a steam cracker to produce lower olefins.

Among other factors, the present process allows one to evaluate and select zeolite-based catalysts which can be used in hydrocracking a n-paraffin containing feedstock with minimal iso-paraffin production. The present hydrocracking process thereby permits one to utilize a straight-forward and efficient catalytic process for hydroconverting normal paraffins into lighter normal paraffins while avoiding the present expensive and inefficient commercial separation processes.

### BRIEF DESCRIPTION OF THE FIGURES OF THE DRAWING

FIG. 1 is the XRD pattern of the LTA-type zeolite prepared in Example 1.

FIG. 2 graphically depicts the conversion yield vs. reaction temperature for the run in Example 4.

FIG. 3 graphically depicts the yield vs. conversion for the run in Example 4.

FIG. 4 graphically depicts the distribution of mono-branched C₁₀ isomers in the hydroisomerization product of Example 4.

FIG. 5 graphically depicts the cracking product distribution at the cracking yield of 2.2 mol. % for the run in Example 4.

FIG. 6 graphically depicts the cracking product distribution at the cracking yield of 5.8 mol. % for the run in Example 4.

FIG. 7 graphically depicts the cracking product distribution at the cracking yield of 10.8 mol. % for the run in Example 4.

FIG. 8 graphically depicts the cracking product distribution at the cracking yield of 14.6 mol. % for the run in Example 4.

FIG. 9 graphically depicts the cracking product distribution at the cracking yield of 20.6 mol. % for the run in Example 4.

FIG. 10 graphically depicts the cracking product distribution at the cracking yield of 28.2 mol. % for the run in Example 4.

FIG. 11 graphically depicts the cracking product distribution at the cracking yield of 39.1 mol. % for the run in Example 4.

FIG. 12 graphically depicts the cracking product distribution at the cracking yield of 50.3 mol. % for the run in Example 4.

FIG. 13 graphically depicts the cracking product distribution at the cracking yield of 65.9 mol. % for the run in Example 4.

### DETAILED DESCRIPTION

### Definitions

Hydroconversion and hydroconvert: A catalytic process which operates at pressures greater than atmospheric in the presence of hydrogen and which converts normal paraffins into lighter normal paraffins with a minimum of isomerization and without excessive formation of methane and ethane. Hydrotreating and hydrocracking are distinctly different catalytic processes but which also operate at pressures greater than atmospheric in the presence of hydrogen. Hydrocracking converts normal paraffins into lighter products comprising significant amounts of iso-paraffins. Hydrotreating does not convert significant quantities of the feedstock to lighter products but does remove impurities such as sulfur- and nitrogen-containing compounds. Also in comparative contrast, thermal cracking converts normal paraffins into lighter products with a minimum of branching, but this process does not use a catalyst, typically operates at much higher temperatures, forms more methane, and makes a mixture of olefins and normal paraffins.

An “aperture” in a zeolite is the narrowest passage through which an absorbing or desorbing molecule needs to pass to get into the zeolite's interior. The diameter of the aperture, dₐₚₚ (nm), is defined as the average of the shortest, dₛₕₒᵣₜ (nm), and the longest, d_{long} (nm) axis provided in the IZA (International Zeolite Association) Zeolite Atlas (http://www.iza-structure.org/databases/). Both normal- and iso-paraffins with a methyl group can pass through apertures with a d_{long}≥0.50 nm, but only normal-paraffins can pass through apertures with d_{long}<0.50 nm provided dₛₕₒᵣₜ>0.30 nm.

Apertures provide access to “voids”, the wider parts in the zeolite topology. The diameter of the void, d_{void} (nm), is characterized by the maximum diameter of a sphere that one can inflate inside such a void as per the IZA Zeolite Atlas (http://www.iza-structure.org/databases/). This characterizes, e.g., a fairly spherical LTA-type void (or cage) as one with a diameter of 1.1 nm, and an elongated AFX-type void as one with a spherical diameter of 0.78 nm. Voids are defined as cages if d_{void}/dₐₚₚ≥1.4 nm/nm.

The present process hydroconverts normal paraffins into lighter normal paraffins with minimal formation of iso-paraffins. The process comprises hydroconverting a hydrocarbon feedstock comprising normal paraffins under hydrocracking conditions, in the presence of a zeolite based catalyst, where the zeolite has voids greater than 0.50 in diameter, accessible through apertures characterized by a longest diameter of less than 0.50 nm and a shortest diameter of more than 0.30 nm. The present zeolite also exhibits an iC₄/nC₄ product ratio of less than 0.5 in nC₁₀ hydrocracking, and in one embodiment less than 0.25, and even less than 0.15. More specifically, the zeolite can be loaded with 0.1 to 0.5 wt. % Pd, reducing the catalyst and running it at about 80% n-C₁₀ conversion at about 600° F. (315° C.), 1200 psig total pressure, 0.5 LHSV and 5:1 H₂/n-C₁₀ molar ratio. The resulting iC₄/nC₄ in the product is less than 0.50, less than 0.25, or even 0.15. Once chosen and confirmed, the zeolite can be loaded with a hydrogenation function metal to create a catalyst for use in the present process.

It is the zeolite base into which the metal is loaded that is critical to the present processes. For it has been found that a selected zeolite catalyst in accordance herewith can provide the high conversion and minimal formation of iso-paraffins. It has been found that the key features of the catalyst zeolite include access to a pore system through apertures of a size less than 0.45 nm, and with the pore system containing voids greater than 0.50 nm in diameter. In another embodiment, the zeolite has voids greater than 0.50 nm in diameter, which are accessible through apertures characterized by a longest diameter of less than 0.5 nm and a shortest diameter of more than 0.30 nm. Zeolite frameworks that meet these criteria include an LTA-type zeolite, as well as a zeolite which has an ITE framework (e.g., SSZ-36) and an SAS framework (e.g., SSZ-73).

Zeolite A (Linde Type A, framework code LTA) is one of the most used zeolites in separations, adsorption, and ion exchange. This structure contains large spherical cages (diameter ^{˜}11.4 Å) that are connected in three dimensions by small 8-membered ring (8MR) apertures with a diameter of 4.1 Å. LTA is normally synthesized in hydroxide media in the presence of sodium with Si/Al ^{˜}1. By changing the cation, the limiting diameter of the 8MR apertures can be tuned, creating the highly used series of adsorbents 3A (potassium form, 2.9 Å diameter), 4A (sodium form, 3.8 Å diameter) and 5 Å (calcium form, 4.4 diameter) that are used to selectively remove species such as water, NH₃, SO₂, CO₂, H₂S, C₂H₄, C₂H₆, C₃H₆ and other n-paraffins from gases and liquids. While LTA is used in vast quantities for the aforementioned applications, the low framework Si/Al ratio and subsequent poor hydrothermal stability limits its use under more demanding process conditions that are commonly found in catalytic applications.

The ITE framework is shown in zeolite SSZ-36, which is described in detail in U.S. Pat. No. 6,218,591. The SAS framework is shown in zeolite SSZ-73, which is described in detail in U.S. Pat. No. 7,138,099.

The following table provides examples of framework types identified by their IZA three-letter code having the necessary characteristics to qualify as a zeolite base for a catalyst useful in the present process. Included in the table are LTA, ITE, and SAS zeolites. In the table, the d-short, d-long, d-sphere values are the pore dimensions given in Angstroms at the IZA web site. The values given in the table are in Angstroms. The ring size specifies the number of oxygen atoms that constitute the aperture providing access into and egress from the void.

| IZA | ring | | | Ratio of d- | | d- | Ratio of d- |
|---|---|---|---|---|---|---|---|
| Code | size | d-short | d-long | long/d-short | d-avg | sphere | sphere/d-avg |
| AVE | 8 | 3.0 | 5.3 | 1.77 | 4.15 | 6.86 | 1.65 |
| MTF | 8 | 3.6 | 3.9 | 1.08 | 3.75 | 6.25 | 1.67 |
| LEV | 8 | 3.6 | 4.8 | 1.33 | 4.20 | 7.10 | 1.69 |
| IHW | 8 | 3.5 | 4.3 | 1.23 | 3.90 | 6.67 | 1.71 |
| RTE | 8 | 3.7 | 4.4 | 1.19 | 4.05 | 7.06 | 1.74 |
| SWY | 8 | 3.9 | 4.0 | 1.03 | 3.95 | 7.06 | 1.79 |
| AFV | 8 | 3.3 | 4.5 | 1.36 | 3.90 | 7.08 | 1.82 |
| AVL | 8 | 3.3 | 4.5 | 1.36 | 3.90 | 7.14 | 1.83 |
| SFW | 8 | 4.1 | 4.1 | 1.00 | 4.10 | 7.78 | 1.90 |
| DDR | 8 | 3.6 | 4.4 | 1.22 | 4.00 | 7.66 | 1.92 |
| AWW | 8 | 3.9 | 3.9 | 1.00 | 3.90 | 7.48 | 1.92 |
| AEI | 8 | 3.8 | 3.8 | 1.00 | 3.80 | 7.33 | 1.93 |
| CHA | 8 | 3.8 | 3.8 | 1.00 | 3.80 | 7.37 | 1.94 |
| ITE | 8 | 3.8 | 4.3 | 1.13 | 4.05 | 8.30 | 2.05 |
| RTH | 8 | 3.8 | 4.1 | 1.08 | 3.95 | 8.18 | 2.07 |
| AFT | 8 | 3.6 | 3.8 | 1.06 | 3.70 | 7.75 | 2.09 |
| SAS | 8 | 4.2 | 4.2 | 1.00 | 4.20 | 8.99 | 2.14 |
| AFX | 8 | 3.4 | 3.6 | 1.06 | 3.50 | 7.76 | 2.22 |
| IRN | 8 | 3.4 | 4.8 | 1.41 | 4.10 | 9.17 | 2.24 |
| SAV | 8 | 3.9 | 3.9 | 1.00 | 3.90 | 8.82 | 2.26 |
| UFI | 8 | 3.6 | 4.4 | 1.22 | 4.00 | 10.09 | 2.52 |
| LTN | 8 | 4.0 | 4.0 | 1.00 | 4.00 | 10.13 | 2.53 |
| PWN | 8 | 4.0 | 4.0 | 1.00 | 4.00 | 10.47 | 2.62 |
| LTA | 8 | 4.1 | 4.1 | 1.00 | 4.10 | 11.05 | 2.70 |
| KFI | 8 | 3.9 | 3.9 | 1.00 | 3.90 | 10.67 | 2.74 |
| MWF | 8 | 3.8 | 3.8 | 1.00 | 3.80 | 10.46 | 2.75 |
| RHO | 8 | 3.6 | 3.6 | 1.00 | 3.60 | 10.43 | 2.90 |
| PAU | 8 | 3.6 | 3.6 | 1.00 | 3.60 | 10.48 | 2.91 |
| NPT | 8 | 3.2 | 3.2 | 1.00 | 3.20 | 10.28 | 3.21 |
| TSC | 8 | 4.2 | 4.2 | 1.00 | 4.20 | 16.45 | 3.92 |

The hydrocracking or hydroconversion catalyst useful in the present processes can typically contain a catalytically active hydrogenation metal. The presence of a catalytically active hydrogenation metal leads to product improvement, especially IV and stability. Typical catalytically active hydrogenation metals include chromium, molybdenum, nickel, vanadium, cobalt, tungsten, zinc, platinum, and palladium. The metals platinum and palladium are especially preferred, with platinum most especially preferred. If platinum and/or palladium is used, the total amount of active hydrogenation metal is typically in the range of 0.1 wt. % to 5 wt. % of the total catalyst, usually from 0.1 wt. % to 2 wt. %.

The zeolite is loaded with a hydrogenation function metal or a mixture of such metals. Such metals are known in the art and have been discussed generally earlier. The preferred metal is typically either a noble metal, such as Pd, Pt, and Au, or a base metal, such as Ni, Mo and W. A mixture of the metals and their sulfides can be used. The loading of the zeolite with the metals can be accomplished by techniques known in the art, such as impregnation or ion exchange. The hydrogenation function metal is loaded on such a selected zeolite to create the catalyst. The created catalyst can then be used in the hydroconversion process.

The feedstock for the process is a hydrocarbon feedstock which comprises at least 5 wt. % normal paraffins. Greater benefit is achieved when the hydrocarbon feedstock comprises at least 20 wt. %, even better when at least 50 wt. % normal paraffins, and in particular at least 80 wt. % normal paraffins. Due to the high content of normal paraffins, the feedstock can be referred to as a waxy feed. Such feedstocks can be obtained from a wide variety of sources, including whole crude petroleum, reduced crudes, vacuum tower residua, synthetic crudes, foots oils, FischerTropsch derived waxes, and the like. Typical feedstocks can include hydrotreated or hydrocracked gas oils, hydrotreated lube oil raffinates, brightstocks, lubricating oil stocks, synthetic oils, foots oils, Fischer-Tropsch synthesis oils, high pour point polyolefins, normal alphaolefin waxes, slack waxes, deoiled waxes and microcrystalline waxes. Other hydrocarbon feedstocks suitable for use in processes of the present process scheme may be selected, for example, from gas oils and vacuum gas oils; residuum fractions from an atmospheric pressure distillation process; solvent-deasphalted petroleum residua; shale oils, cycle oils; animal and vegetable derived fats, oils and waxes; petroleum and slack wax; and waxes produced in chemical plant processes.

In an embodiment, the feedstock's aromatics and organic nitrogen and sulfur content is reduced. This can be achieved by hydrotreating the feedstock prior to the hydroconversion. Contacting the feedstock with a hydrotreating catalyst may serve to effectively hydrogenate aromatics in the feedstock and to remove N- and S-containing compounds from the feed.

The conditions under which the present processes are carried out will generally include a temperature within a range from about 390° F. to about 800° F. (199° C. to 427° C.). In an embodiment, each of the first and second hydroisomerization dewaxing conditions includes a temperature in the range from about 550° F. to about 700° F. (288° C. to 371° C.). In a further embodiment, the temperature may be in the range from about 590° F. to about 675° F. (310° C. to 357° C.). The pressure may be in the range from about 50 to about 5000 psig, and typically in the range from about 100 to about 2000 psig.

Typically, the feed rate to the catalyst system/reactor during dewaxing processes of the present invention may be in the range from about 0.1 to about 20 h⁻¹ LHSV, and usually from about 0.1 to about 5 h⁻¹ LHSV and, in one embodiment from 0.5 to about 2 h⁻¹ LHSV. Generally, dewaxing processes of the present invention are performed in the presence of hydrogen. Typically, the hydrogen to hydrocarbon ratio may be in a range from about 2000 to about 10,000 standard cubic feet H₂ per barrel hydrocarbon feed, and usually from about 2500 to about 5000 standard cubic feet H₂ per barrel hydrocarbon feed.

The per-pass conversion of the n-paraffins in the feedstock to lighter products is generally between 25 and 99%, and mostly between 40 and 80%.

The normal paraffin-rich product recovered from the hydroconversion can then be passed to a steam cracker. The product recovered from the present hydroconversion process, thanks to the use of a catalyst based on the selected zeolite, does not require any separation step before it is fed to a steam cracker. The steam cracking process is known in the art. Steam cracking a hydrocarbon feedstock produces olefin streams containing olefins such as ethylene, propylene, and butenes. The present hydroconversion process provides an excellent feedstock for a steam cracker.

### Example 1

### Synthesis of LTA Zeolite

The following route, as described in U.S. Pat. No. 9,821,297, was employed for the synthesis of LTA:

The structure directing agent (SDA), 2,3-dimethyl-1-(4-methyl-benzyl)-3H-imidazol-1-ium cation, employed in this synthesis is depicted below. 4.17 g of tetraethylorthosilicate (TEOS), 0.24 g of tetramethylammonium (TMA) pentahydrate, 11.89 g of a hydroxide solution of the SDA (0.84 mmol/g) were combined in a 23 mL PEEK cup. This mixture was sealed and shaken for 24-hours to allow complete hydrolysis of the TEOS. Then 0.19 g of aluminum hydroxide and 0.05 g of LTA-seeds were added. To remove excess water, the mixture was then left open at 90° C. for 12 hours. Subsequently, the dried mixture was ground and 0.39 g of HF (50 wt. % solution) were added. The final molar composition of the gel was as follows:

1 SiO: 0.05 AlO: 5 H₂O: 0.5 SDA-OH: 0.07 TMA-OH: 0.5 HF

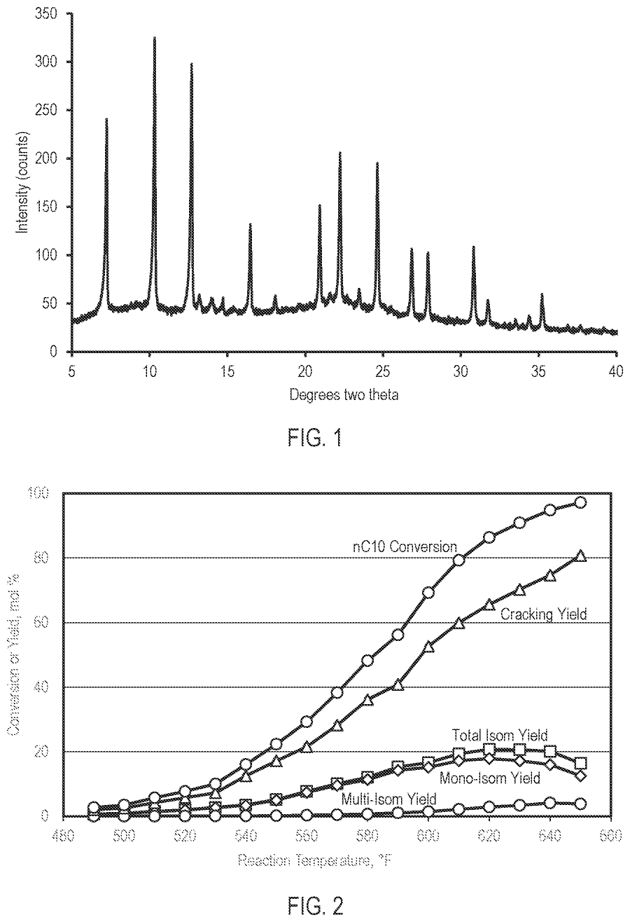

The PEEK cup was capped and sealed in a stainless steel autoclave and heated at 175° C. for 72 hours. Upon crystallization, the gel was recovered from the autoclave, filtered and washed with deionized water. The resulting product was analyzed by powder XRD. The resulting XRD pattern is shown in FIG. 1. The as-synthesized product had a SiO₂/Al₂O₃ mole ratio of 25, as determined by ICP elemental analysis.

SDA:

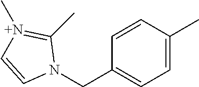

### Example 2

### Preparation of Pd/LTA

Material from Example 1 was calcined in air at 1103° F. for 5 hours to remove the organic SDA molecules occluded in the channels/cages of the zeolite and to convert it into its proton form. 0.93 g of the calcined LTA zeolite material was then loaded with palladium by mixing under shaking for three days at room temperature first with 5.6 g of deionized water and then 0.51 g of a (NH₃)₄Pd(NO₃)₂ solution (buffered at pH 9.5 with a 0.148 N NH₄OH solution) such that 1 g of this (NH₃)₄Pd(NO₃)₂ solution mixed in with 1 g of zeolite provided a 0.55 wt. % Pd loading. The recovered Pd-exchanged zeolite was washed with deionized water, dried at 200° F., and then calcined at 650° F. for 3 hours. The calcined Pd/LTA catalyst was then pelletized, crushed and sieved to 20-40 mesh for catalytic testing.

### Example 3

Procedure for Catalytic Test with n-C₁₀

For catalytic testing, 0.44 g (0.7 ml, 20-40 mesh) of the Pd/LTA catalyst from Example 2, equivalent to 0.40 g when dried at 1112° F. according to thermogravimetric analysis, was loaded in the center of a 23 inch-long by 0.25 inch outside diameter stainless steel reactor tube with catalytically inactive alundum loaded on both sides of the zeolite catalyst bed. The catalyst is then reduced in flowing hydrogen at about 600° F. (315° C.) for 5 hours. The catalytic reaction was carried out at a total pressure of 1200 psig; a down-flow hydrogen rate of 6.25 mL/min, when measured at 1 atmosphere pressure and 75° F. (24° C.); a down-flow liquid feed rate of 0.5 mL/hour; and a reaction temperature ranging from 490 to 650° F. (254-343° C.). Products were analyzed by on-line capillary gas chromatography (GC) once every 60 minutes. Raw data from the GC was collected by an automated data collection/processing system and hydrocarbon conversions were calculated from the raw data. Conversion is defined as the amount n-decane reacted in mol % to produce products including both (i) cracking products (C₉₋) and (ii) isomerization products (iso-C₁₀ isomers). Yields are expressed as molar percent of the n-decane feed converted to products which are other than n-decane, namely, cracking products (C₉₋) and isomerization products (iso-C₁₀ isomers).

### Example 4

Catalytic Test of Pd/LTA with n-C10

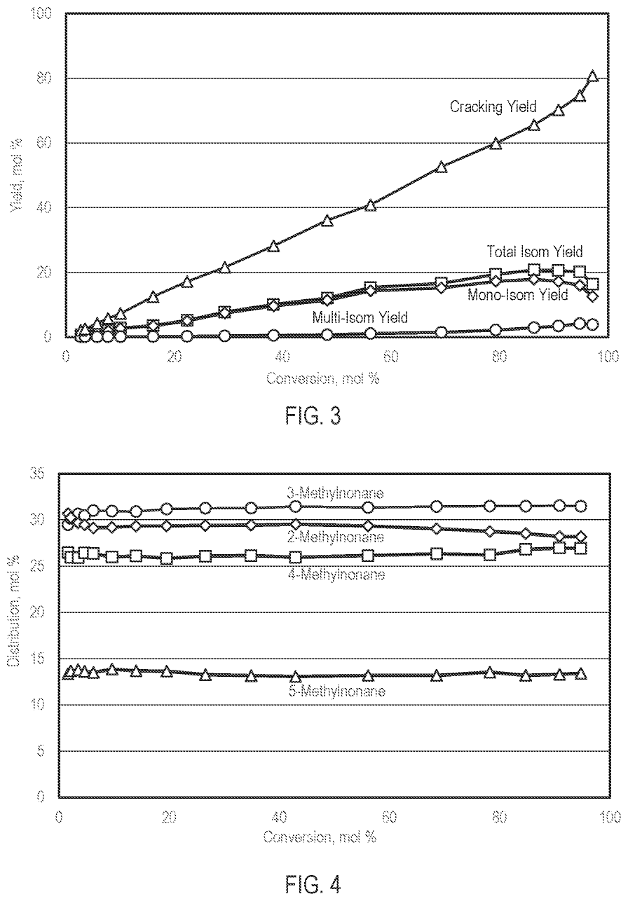

The palladium-exchanged LTA sample from Example 2 was tested for the selective hydroconversion of n-decane under the conditions described in Example 3. The results are presented in FIGS. 2-4. The results show that the more than 95% of the n-decane feed is converted. The conversion of n-decane increases with the increasing reaction temperature. As shown in FIGS. 2-3, at low temperatures, both hydrocracking and hydroisomerization already take place simultaneously over this catalyst. When the reaction temperature increases, the yields to both hydrocracking and hydroisomerization go up. With the competing hydrocracking reaction occurring, as the temperature increases further, the yield to hydroisomerization products proceeds to a maximum and then decrease. It is to note that, as shown in FIGS. 2-3, hydrocracking predominates over hydroisomerization throughout the entire temperature range from 490 to 650° F. under the conditions applied in this example. Furthermore, mono-branched C₁₀ isomers predominate over multi-branched C₁₀ isomers in the hydroisomerization product. The distribution of the mono-branched C₁₀ isomers (namely, 2-, 3-, 4- and 5-methylnonane) is approximately independent on the reaction temperature in then following order as shown in FIG. 4: 3MC9>2MC9>4MC9>5MC9.

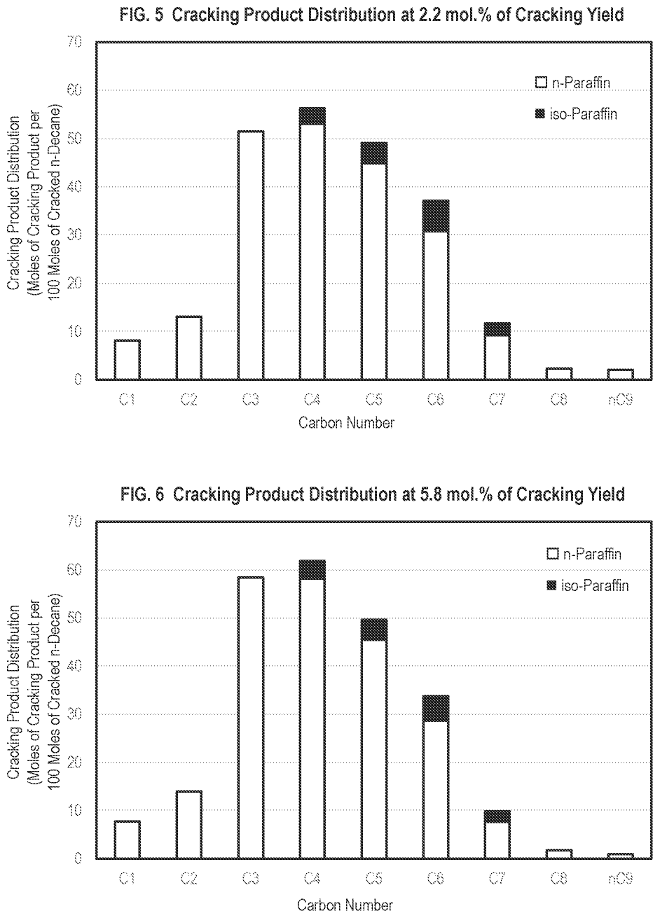

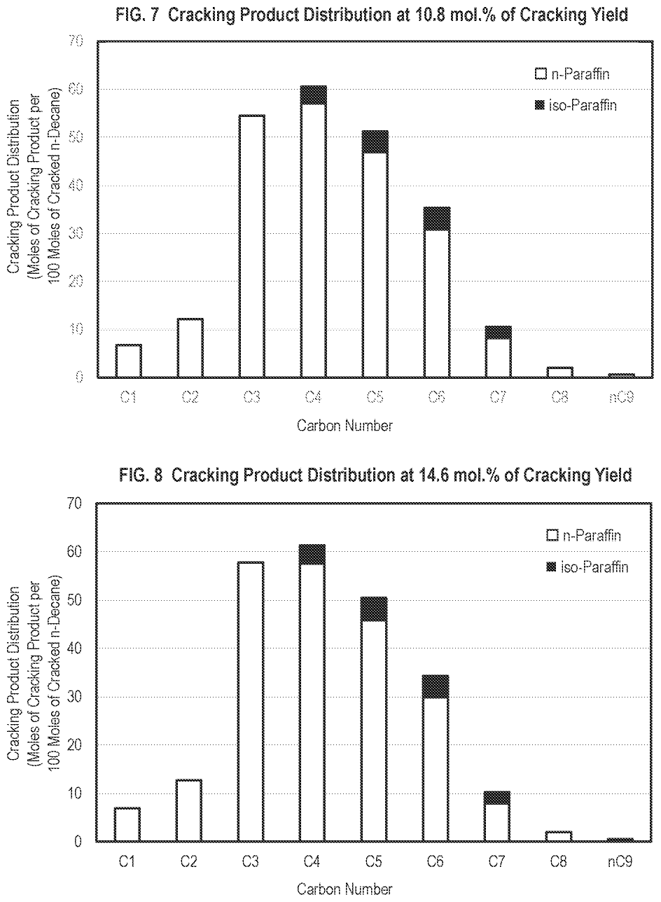

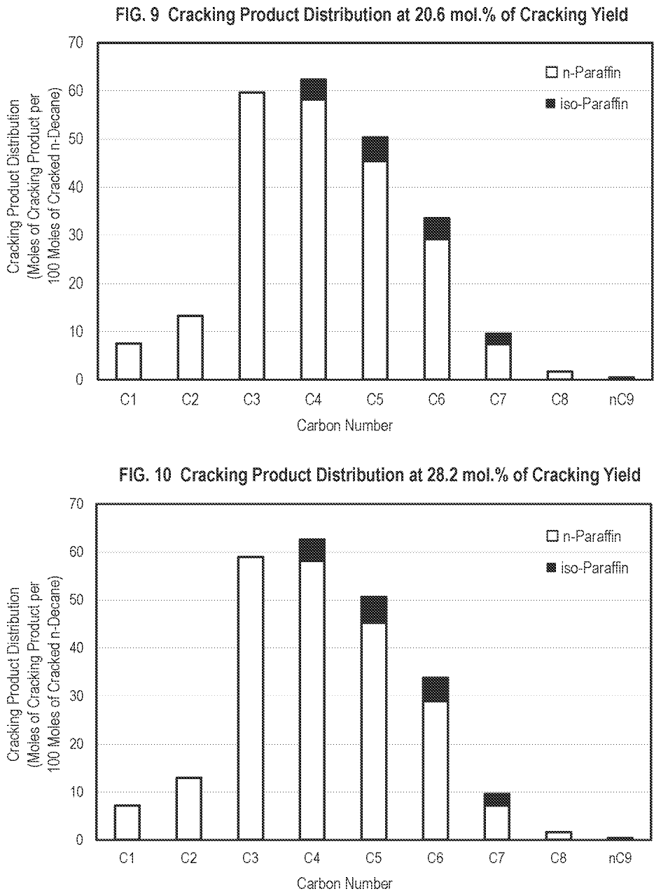

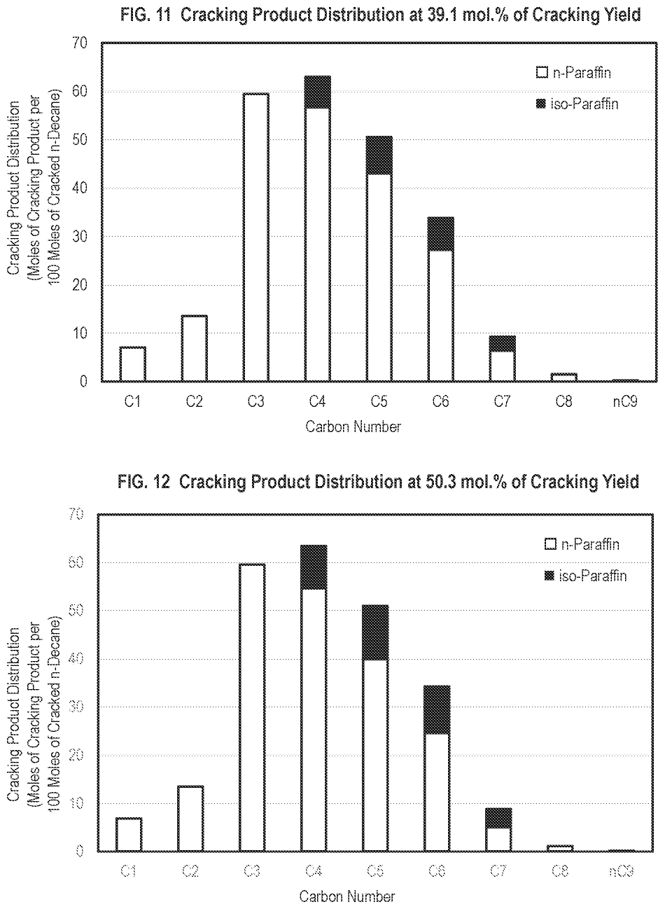

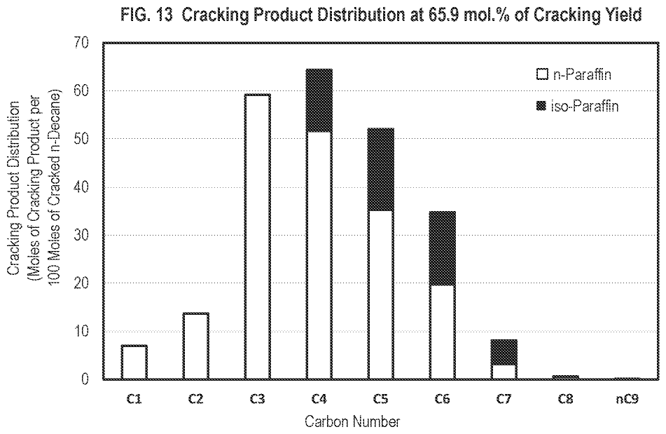

Another important feature of the catalyst of this example is the selective hydrocracking of n-decane to normal paraffin rich lighter products. As shown in FIGS. 5-13, the cracking products (C₄-C₉) consist predominantly of normal paraffins over iso-paraffins in the cracking yield range of 2.2 to 65.9 mol. %.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A zeolite-based catalyst with the requisite topology and acid site density that permits hydroconversion of normal paraffins to a normal paraffin-rich lighter product, comprising:
a) a zeolite that has framework type with voids greater than 0.50 nm in diameter, which are accessible through apertures characterized by a longest diameter of less than 0.50 nm and a shortest diameter of more than 0.30 nm;
b) a hydrogenation function; and
c) which in n-C₁₀ hydrocracking exhibits an iC₄/nC₄ product ratio of less than 0.25.

2. A process for hydroconversion of normal paraffins, comprising:
subjecting a hydrocarbon feedstock comprising at least 3 wt. % normal paraffins to a hydroconversion reaction under hydroconversion conditions in the presence of a zeolite-based catalyst with voids greater than 0.50 nm in diameter, which are accessible through apertures characterized by a longest diameter of less than 0.50 nm and a shortest diameter of more than 0.30 nm.

3. The process of claim 2, wherein the zeolite of the catalyst comprises a AVE, MTF, LEV, IHW, RTE, SWY, AFV, AVL, SFW, DDR, AWW, AEI, CHA, EEI, ITE, RTH, AFT, SAS, AFX, IRN, SAV, UFI, LTN, PWN, LTA, KFI, NWF, RHO, PAU, NPT, or TSC framework types.

4. The process of claim 3, wherein the zeolite of the catalyst is an LTA-type zeolite.

5. The process of claim 2, wherein the zeolite of the catalyst comprises an eight membered ring and d-sphere/d-avg is greater than or equal to 1.4.

6. The process of claim 2, wherein the zeolite selected is loaded with a hydrogenation function metal.

7. The process of claim 6, wherein the hydrogenation function metal comprises a noble metal.

8. The process of claim 7, wherein the noble metal comprises Pd, Pt, Au or a mixture thereof.

9. The process of claim 6, wherein the hydrogenation function metal component comprises Ni, Mo, W, their sulfides, or a mixture thereof.

10. The process of claim 6, wherein the loaded selected zeolite is used in a hydroconversion reaction of hydroconverting normal paraffins to a normal paraffin-rich lighter product with the feedstock comprising at least 5 wt. % normal paraffins.

11. The process of claim 10, wherein the zeolite of the catalyst is an LTA- or TSC-type zeolite.

12. The process of claim 10, wherein the feedstock comprises at least 10 wt. % normal paraffins.

13. The process of claim 10, wherein the feedstock is a petroleum feedstock or a petroleum based feedstock.

14. The process of claim 10, wherein the feedstock is subjected to a hydrotreatment prior to the hydroconversion reaction.

15. The process of claim 10, wherein the per-pass conversion of the normal paraffins in the feedstock is between 25 and 99%.

16. A process for preparing a zeolite catalyst useful in the hydroconversion of normal paraffins comprising:
a) choosing a zeolite that has a pore system with access through aperture less than 0.45 nm in diameter and with voids greater than 0.5 nm in diameter;
b) confirming the zeolite in n-C₁₀ hydrocracking exhibits a iC₄/nC₄ in the product less than 0.25; and
c) binding the zeolite into a shaped pellet
d) loading the zeolite-containing pellet with a hydrogenation function metal to thereby prepare a hydroconversion catalyst.

17. The process of claim 16, wherein the chosen zeolite in a) is an LTA-type zeolite.

18. The process of claim 6 or 10, wherein a product is recovered from the reaction and passed to a steam cracker.

19. The process of claim 18, wherein the product is passed to a steam cracker with no separation step before being fed to the steam cracker.
